(19) United States
(12) Patent Application Publication
(10) Pub. No.: US 2006/0096827 A1
(43) Pub. Date: May 11, 2006

(54) Wheel assembly for a motorized vehicle

(76) Inventor: Pao-Ling Lee, Taipei (TW)

Correspondence Address: BRUCE H. TROXELL;SUITE 1404, 5205 LEESBURG PIKE, FALLS CHURCH, VA, 22041, US

(21) Appl. No.: 10/981,490

(22) Filed: Nov. 5, 2004

(51) Int. Cl. F16D 41/24

(52) U.S. Cl. 192/45; 192/46

(57) ABSTRACT

A wheel assembly includes a driven member and a rotating member sleeved rotatably on an axle. The driven member includes a primary part, and a secondary part that is sleeved rotatably around the primary part, and that cooperates with the primary part to form a tongue-receiving space therebetween. A tongue-defining wall having opposite large and narrow wall sections confines the tongue-receiving space. An engagement tongue is disposed movably within the tongue-receiving space. An urging member urges the tongue to engage the narrow wall section of the tongue-confining wall, thereby coupling the primary and secondary parts. The rotating member has a pushing arm parallel to the axle, and extends into the narrow wall section in such a manner so as to be disposed at one side of the engagement tongue opposite to the urging member.

### FIELD OF THE INVENTION

The present invention generally relates to a wheel assembly, more particularly to a wheel assembly for a motorized vehicle. In case the motor is unable to operate the vehicle, applying a relatively low external force thereon can manually rotate the wheel assembly.

### BACKGROUND OF THE INVENTION

FIG. 1 shows a motorized bicycle disclosed according to U.S. Pat. No. 5,450,915, and includes a fork 4, an axle 1 fixed to the fork 4, an outer casing 2, and a wheel assembly 3 mounted on the axle 1 via the outer casing 2. An electric motor (not visible) is mounted within the outer casing 2 and is controlled by a programmable control circuit (not visible) to change rotation speed of the wheel assembly 3.

One drawback of the aforesaid motorized bicycle resides in that the wheel assembly includes several components, such as left and right outer casings and motor casing, the construction and assembly thereof is complicated and expensive. In addition, since one-way clutch is employed in the electric motor of the aforesaid bicycle, it requires a relatively large force to manually move the wheel assembly in case the electric motor is unable to operate the same, thereby causing inconveniences to the rider.

### SUMMARY OF THE INVENTION

The main object of the present invention is to provide a wheel assembly for use in a motorized bicycle. The wheel assembly has simple construction and includes components lesser than that of the aforesaid wheel assembly so that the present wheel assembly can be manually moved with ease by applying a relatively low force so as to move the wheel assembly in case the motor is unable operate the same.

According to the present invention, a wheel assembly is provided for a motorized vehicle that includes a fork having two fork arms and a wheel to be carried by the fork arms. The wheel assembly includes: an axle adapted to be mounted securely to the fork arms; a driven member including a primary part mounted rotatably on the axle, and a secondary part that is sleeved rotatably around the primary part, that is adapted to be coupled securely to the wheel for co-rotation therewith and that cooperates with the primary part to form a tongue-receiving space therebetween, the tongue-receiving space being confined by a tongue-defining wall having a large wall section and a narrow wall section opposite to the large wall section; an engagement tongue disposed movably within the tongue-receiving space; an urging member urging the engagement tongue to engage the narrow wall section of the tongue-confining wall, thereby coupling the primary and secondary parts together to permit synchronous rotation of the primary and secondary parts about the axle when the primary part rotates in a predetermined direction; and a one-way rotating member sleeved rotatably on the axle, juxtaposed to the driven member, and having a lateral side face and a pushing arm projecting from the lateral side face parallel to the axle extending into the narrow wall section in such a manner so as to be disposed at one side of the engagement tongue opposite to the urging member. The rotating member rotates together with the driven member in the predetermined direction.

### BRIEF DESCRIPTION OF THE DRAWINGS

The foregoing aspects and many attendant advantages of the present invention will become more readily appreciated as the same becomes better understood by reference to the following detailed description, when taken in conjunction with the accompanying drawings, of which:

FIG. 1 is a fragmentary side view of a motorized bicycle disclosed according to U.S. Pat. No. 5,450,915;

FIG. 2 is a fragmentary perspective view of a portion of the first embodiment of a wheel assembly according to the present invention for use in a motorized vehicle;

FIG. 3A shows a perspective view of a driven member employed in the first embodiment of the wheel assembly of the present invention;

FIGS. 3B, 3C show perspective and top planar views of a one-way rotating member employed in the first embodiment of the wheel assembly of the present invention;

FIGS. 4A and 4B respectively show relative position of a push arm in the rotating member and two different positions of an engagement tongue within the driven member of the first embodiment of the wheel assembly of the present invention;

FIG. 5 is a partly cross-sectional view, illustrating a portion of the second embodiment of a wheel assembly according to the present invention for use in a motorized vehicle; and

FIG. 6 is a partly cross-sectional view, illustrating a portion of the third embodiment of a wheel assembly according to the present invention for use in a motorized vehicle

### DETAILED DESCRIPTION OF THE PREFERRED EMBODIMENTS

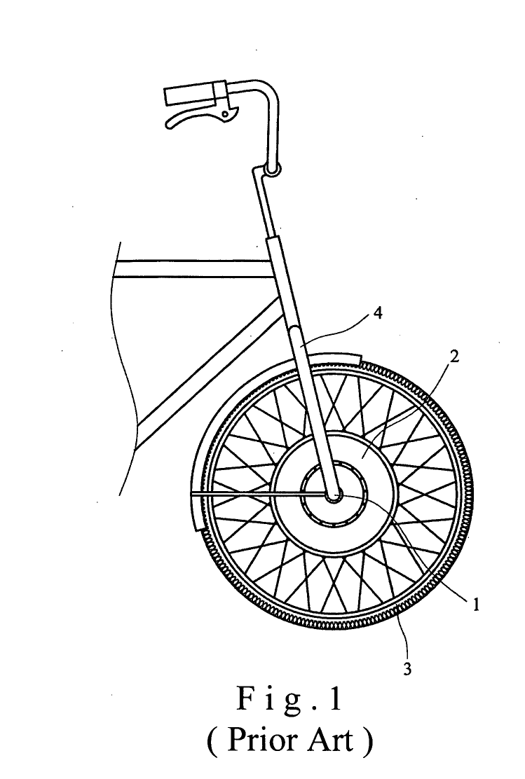

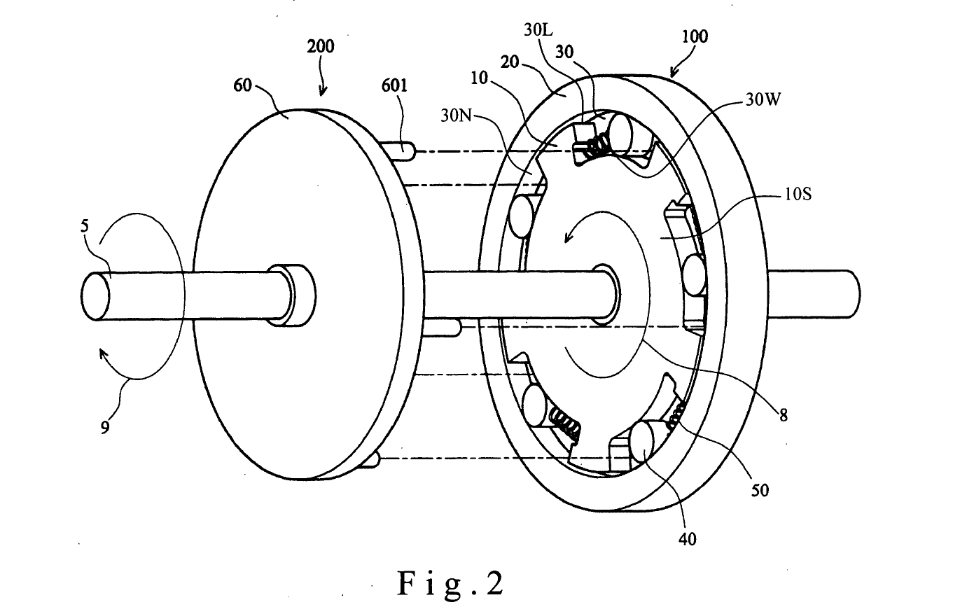

FIG. 2 shows a portion of the first embodiment of a wheel assembly according to the present invention is employed in a motorized bicycle that includes an axle 5 and a fork (see FIG. 1) having two fork arms for carrying the axle 5 thereon. The first embodiment includes a driven member 100, a plurality of urging members 50, a plurality of engagement tongues 40, and a one-way rotating member 200.

As illustrated, a driven member 100 includes a primary part 10 and a secondary part 20. The primary part 10 is mounted rotatably on the axle 5, and includes a plurality of angularly spaced apart segments 10S. An adjacent pair of the segments 10S cooperatively defines a tongue-receiving space 30 therebetween. The secondary part 20, a hollow cylinder, is sleeved rotatably around the segments 10S of the primary part 10, is adapted to be coupled securely to the wheel (see FIG. 1) for co-rotation therewith, and cooperates with the primary part 10 to form a tongue-defining wall 30W confining a respective tongue-receiving space 30. Each of the tongue-confining walls 30W has a large wall section 30L and a narrow wall section 30N (see FIG. 2) opposite to the large wall section 30N.

Each engagement tongue 40 is disposed movably within the respective tongue-receiving space 30.

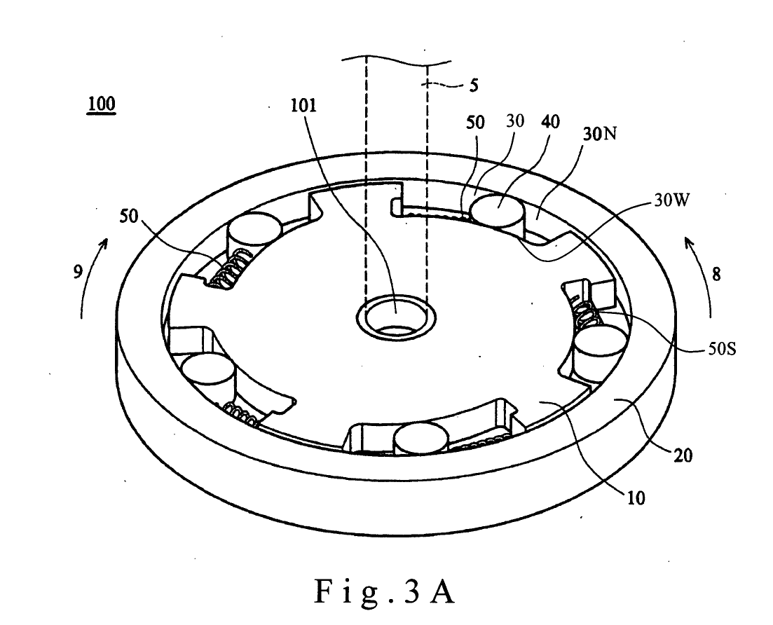

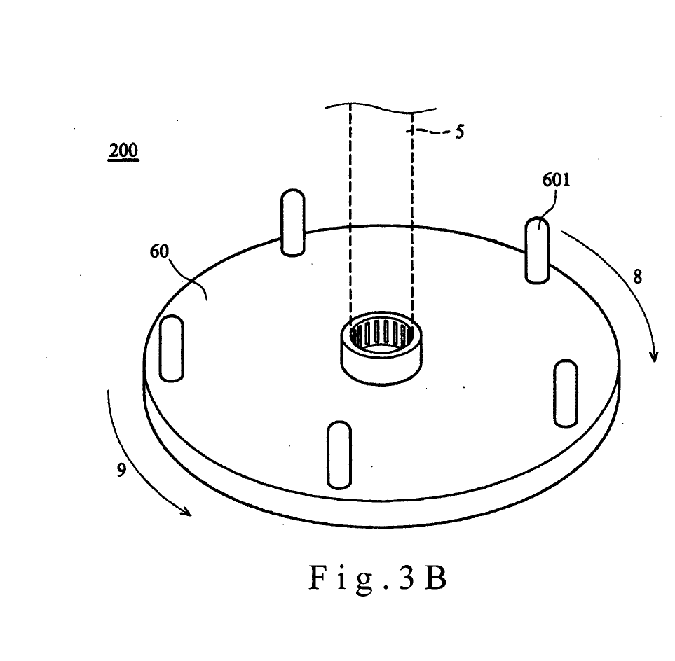

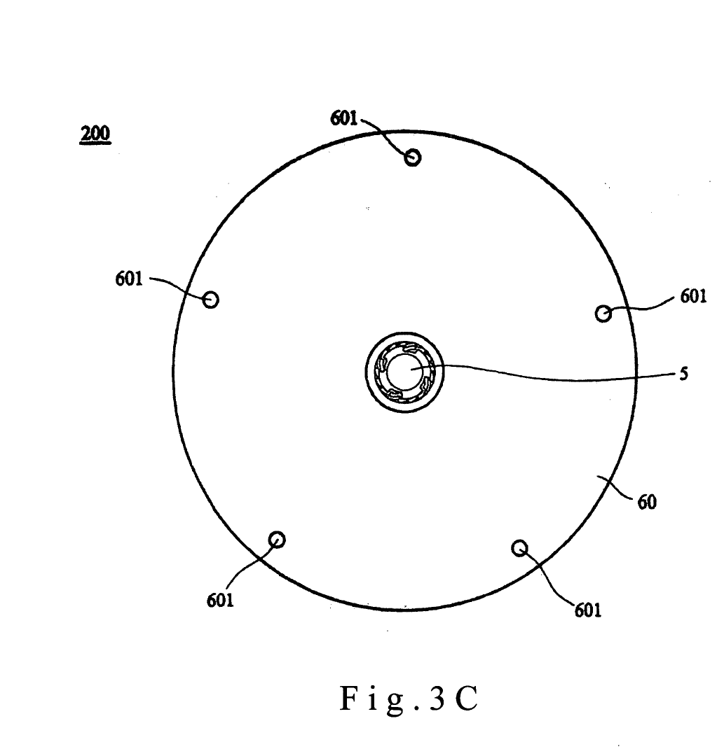

Each urging member 50 is disposed in the respective tongue-receiving space 30, and urges the engagement tongue 40 to engage the narrow wall section 30N of the respective tongue-confining wall 30W (see FIG. 3A), thereby coupling the primary and secondary parts 10, 20 together to permit synchronous rotation of the primary and secondary parts 10, 20 about the axle 5 when the primary part 10 rotates in a clockwise direction 9. Note that the primary part 10 is operably connected to a power-operated motor (not shown) for driving the same in the clockwise direction 9, i.e. forward direction, thereby driving the bicycle. Since the relevant feature of the present invention does not reside in the construction of the motor, a detailed description thereof is omitted herein for the sake of brevity.

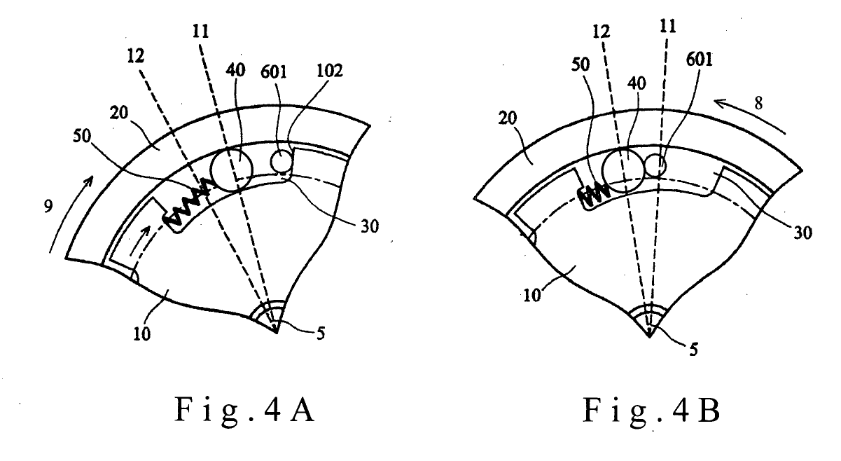

The rotating member 200, preferably a driving disc 60, is sleeved rotatably on the axle 5, is juxtaposed to the driven member 100, and has an inner lateral side face and a plurality of angularly spaced apart pushing arms 601 projecting from the inner lateral side face parallel to the axle 5 (see FIGS. 3B and 3C). Each of the pushing arms 601 extends into the narrow wall section 30N of the respective tongue-receiving space 30 in such a manner the pushing arm 601 is disposed at one side of the engagement tongue 40 opposite to the corresponding urging member 50. Under this condition when the primary part 10 is driven to rotate in the clockwise direction 9 (see FIG. 4A), the engagement tongue 40 pushes consequently the pushing arms 601 of the rotating member 200 in the forward direction by virtue of clamping action of the primary and secondary parts 10 via the tongue 40. In case, the power-motor is unable to operate the wheel assembly of the present invention, the latter can be manually pushed to rotate in the clockwise direction 9 due to engagement of the engagement tongue between the primary and secondary parts 10,20. In the same manner, when the wheel assembly is manually rotated in an anti-clockwise direction 8, as shown in FIG. 4B, the pushing arm 601 moves synchronously with the tongue 40 and the primary and secondary parts 10, 20 from the position 11 to the position 12 (see FIG. 4B) for a predetermined angular distance due to engagement of the tongue 40 between the primary and secondary parts 10, 20. Upon reaching the position 12, the tongue 40 disengages from one of the primary and secondary parts 10, 20 (see FIG. 4B) such that the user only needs to apply a relatively low force in order to rotate the wheel assembly in the anti-clockwise direction if he desires.

In the first embodiment, each of the engagement tongue 40 is a rolling ball. Alternatively, the engagement tongue 40 can be a cylindrical roller. Each of the urging members 50 is a compression spring having a first end secured to a respective segment 10S and a second end urging the respective tongue 40 into the narrow wall section 30N. Preferably, a protective sheath 50S (see FIG. 3A) can be sleeved around the compression spring.

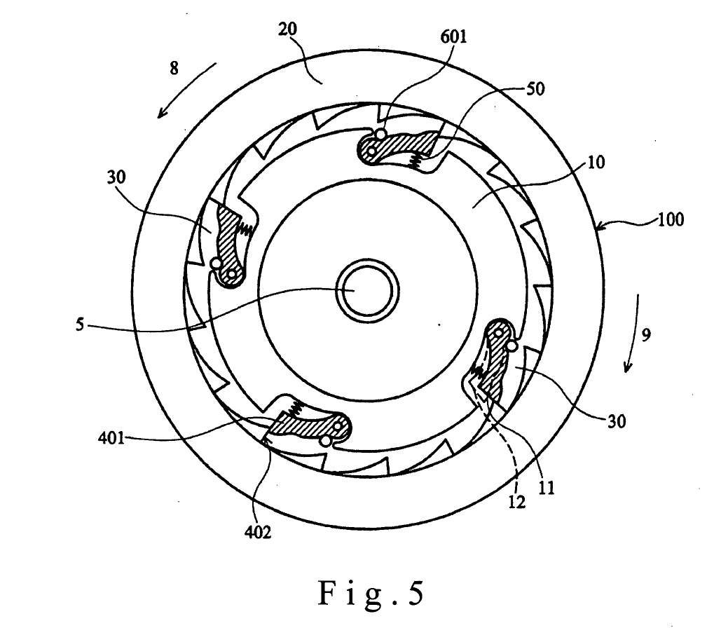

FIG. 5 shows a partly sectional view, illustrating the second embodiment of the wheel assembly of the present invention, and has a construction similar to the previous embodiment. The main difference resides in that each of the engagement tongue employed herein is a ratchet pawl 401 having a first end pivoted to the primary part 10 and a second end engaging the narrow wall section 402 defined by the secondary part 20 by virtue of urging action of the urging member 50.

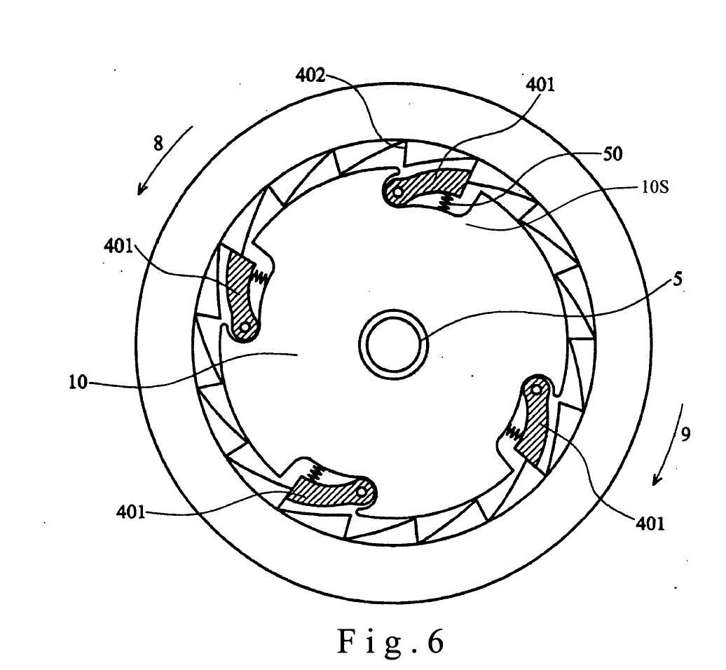

FIG. 6 shows a partly sectional view, illustrating the third embodiment of the wheel assembly of the present invention, and has a construction similar to the second embodiment. The main difference resides in that no pushing arms are employed therein but the position of each ratchet pawl 401 is retained similar to that in FIG. 5, since opposite ends of each compression spring are respectively and securely fastened to the ratchet pawl 401 and an adjacent segment 10S of the primary part 10.

As understood by a person skilled in the art, the foregoing preferred embodiments of the present invention is of illustrative rather than limiting thereon. It is intended to cover various modifications and similar arrangements included within the spirit and scope of the appended claims, the scope of which should be accorded the broadest interpretation so as to encompass all such modifications and similar structure.

I claim:

1. A wheel assembly for a motorized vehicle that includes a fork having two fork arms and a wheel to be carried by the fork arms, comprising:
an axle adapted to be mounted securely to the fork arms;
a driven member including a primary part mounted rotatably on said axle, and a secondary part that is sleeved rotatably around said primary part, that is adapted to be coupled securely to the wheel for co-rotation therewith and that cooperates with the primary part to form a tongue-receiving space therebetween, said tongue-receiving space being confined by a tongue-defining wall having a large wall section and a narrow wall section opposite to said large wall section;
an engagement tongue disposed movably within said tongue-receiving space;
an urging member urging said engagement tongue to engage said narrow wall section of said tongue-confining wall, thereby coupling said primary and secondary parts together to permit synchronous rotation of said primary and secondary parts about said axle when said primary part rotates in a predetermined direction; and
a one-way rotating member sleeved rotatably on said axle, juxtaposed to said driven member, and having a lateral side face and a pushing arm projecting from said lateral side face parallel to said axle extending into said narrow wall section in such a manner so as to be disposed at one side of said engagement tongue opposite to said urging member.

2. The wheel assembly according to claim 1, wherein said engagement tongue is a rolling ball.

3. The wheel assembly according to claim 1, wherein said engagement tongue is a cylindrical roller.

4. The wheel assembly according to claim 1, wherein said engagement tongue is a ratchet pawl having a first end pivoted to said primary part and a second end engaging said narrow wall section defined by said secondary part 20 by virtue of urging action of said urging member.

5. The wheel assembly according to claim 1, wherein said urging member is compression spring.

6. The wheel assembly according to claim 5, further comprising a protective sheath sleeved around said compression spring.

7. The wheel assembly according to claim 1, wherein said primary part includes a plurality of angularly spaced apart segments, an adjacent pair of said segments cooperatively defining said tongue-receiving space.

8. The wheel assembly according to claim 7, wherein said secondary part is a hollow cylinder sleeved rotatably around said segments of said primary part.

9. The wheel assembly according to claim 1, wherein said rotating member includes a rotating disc having two opposite side faces, one of said side faces defining said lateral side face.
